(19) United States
(12) Patent Application Publication
(10) Pub. No.: US 2026/0361901 A1
(43) Pub. Date: Nov. 12, 2026

(54) INFORMATION PROCESSING APPARATUS AND INFORMATION PROCESSING METHOD

(71) Applicant: SONY GROUP CORPORATION, TOKYO (JP)

(72) Inventor: YUJI FUJIMOTO, TOKYO (JP)

(21) Appl. No.: 19/488,094

(22) PCT Filed: May 27, 2024
(86) PCT No.: PCT/JP2024/019317

§ 371 Date: Nov. 26, 2025

(30) Foreign Application Priority Data
Jun. 14, 2023 (JP) 2023-097630

(51) Int. Cl. H04N 19/436; H04N 19/174; H04N 19/96

(52) U.S. Cl. CPC H04N 19/436; H04N 19/174; H04N 19/96

(57) ABSTRACT

The present disclosure includes a number-of-slices determination section configured to determine a number of slices on the basis of a set number of execution cores, set coding performance, and a set speed for a CTU to be encoded, the set number of execution cores, the set coding performance, and the set speed having been input, and a combination determination section configured to determine a combination of a number of CTU parallel operations, a number of CU partition parallel operations, and a number of CU mode parallel operations, the CTU parallel operations, the CU partition parallel operations, and the CU mode parallel operations being to be performed in a respective slice for the number of slices subjected to the determination by the number-of-slices determination section.

### TECHNICAL FIELD

The present disclosure relates to an information processing apparatus and an information processing method.

### BACKGROUND ART

Known parallelization methods of a codec include parallelization methods such as an inter-frame task pipeline, parallelization of non-reference frames, and division encoding. Additionally, known intra-frame parallelization methods that require no frame delay include parallelization methods of slice parallelization and CTU parallelization (WPP).

Here, a “slice” includes a set of CTUs. A “CTU” refers to a number of CUs combined into a block of a fixed size. “CUs” are obtained by dividing a screen into a number of blocks.

### CITATION LIST

### Patent Literature

PTL 1: JP 2011-160077 A

### SUMMARY

### Technical Problem

In the related art, even the parallelization methods such as the slice parallelization and the CTU parallelization (WPP) can meet speed requirements of general application software programs.

However, in recent years, with the advent of video compression standards typified by Versatile Video Coding (VVC) and the like, the amount of processing of a codec of an encoder has increased. Therefore, in order to increase the speed of processing of the codec, a codec method is required that has a higher degree of parallelization than the known codec methods.

The present disclosure has been made in view of the above circumstances, and provides an information processing apparatus and an information processing method capable of performing parallel processing of a codec with a high degree of parallelization.

### Solution to Problem

An information processing apparatus according to the present disclosure includes a number-of-slices determination section configured to determine a number of slices on the basis of a set number of execution cores, set coding performance, and a set speed for a CTU to be encoded, the set number of execution cores, the set coding performance, and the set speed having been input, and a combination determination section configured to determine a combination of a number of CTU parallel operations, a number of CU partition parallel operations, and a number of CU mode parallel operations, the number of CTU parallel operations, the number of CU partition parallel operations, and the number of CU mode parallel operations being to be performed in a respective slice for the number of slices subjected to the determination by the number-of-slices determination section.

### BRIEF DESCRIPTION OF DRAWINGS

FIG. 1 is a diagram for describing an example of processing of a codec method using slice parallelization and CTU parallelization.

FIG. 2 is a diagram for describing an example of processing of a codec method using a CU partition parallelization and a CU mode parallelization.

FIG. 3 is a diagram for describing an enormous amount of processing of mode decision of a VVC encoder.

FIG. 4 is a block diagram illustrating an example of a configuration of an image encoding apparatus which is an aspect of an image processing apparatus according to an embodiment.

FIG. 5 is a block diagram illustrating a main configuration example of a transform quantization section according to an embodiment.

FIG. 6 is a flowchart for describing an example of a flow of encoding processing executed by an image encoding apparatus according to an embodiment.

FIG. 7 is a flowchart for describing an example of a flow of image encoding processing according to an embodiment.

FIG. 8 is a flowchart for describing an example of a flow of image encoding processing according to an embodiment.

FIG. 9 is a functional block diagram illustrating functions of the VVC encoder according to an embodiment.

FIG. 10 is a diagram illustrating a control information database according to an embodiment.

FIG. 11 is a diagram illustrating a control information database for describing determination of the number of slices by a number-of-slices determination section according to an embodiment.

FIG. 12 is a diagram for describing determination of coding performance and a speed by a number-of-slices determination section according to an embodiment.

FIG. 13 is a diagram illustrating a control information database for describing retrieval of a speed value T(S)ₚ by a parallelization method determination section according to an embodiment.

FIG. 14 is a diagram illustrating the control information database for describing retrieval of the number of execution cores by the parallelization method determination section according to an embodiment.

FIG. 15 is a flowchart for describing overall processing for determining a parallel processing method for the encoder according to an embodiment.

FIG. 16 is a diagram illustrating a flowchart of generation of the control information database for the encoder according to the embodiment.

FIG. 17 is a flowchart of determination of the number of slices (S) by the encoder according to an embodiment.

FIG. 18 is a flowchart of determination of a combination of parallelization methods in each slice [W(n), P(n), M(n)] according to an embodiment.

FIG. 19 is a flowchart of a case of estimating the amount of processing A(n) on the basis of a past frame according to an embodiment.

FIG. 20 is a flowchart of a case of estimating the amount of processing A(n) on the basis of a feature amount of an original image or ME according to an embodiment.

FIG. 21 is a flowchart of a case of determining the parallelization methods in each slice {W(n), P(n), M(n)} on the basis of the amount of processing A(n) according to an embodiment.

FIG. 22 is a flowchart of adjustment of the parallelization method pattern in the nth slice with respect to the speed value according to an embodiment;

FIG. 23 is a flowchart of parallelization method pattern adjustment for each slice with respect to the number of execution cores.

FIG. 24 is a diagram illustrating a game server and a game client in a game system according to an embodiment.

FIG. 25 is a hardware configuration diagram illustrating an example of a computer 1000 that realizes a computation apparatus of an information processing apparatus in which a VVC encoder is mounted, according to an embodiment.

### DESCRIPTION OF EMBODIMENTS

Hereinafter, preferred embodiments of the present disclosure will be described in detail with reference to the accompanying drawings. In the present specification and the drawings, components having substantially the same functional configurations are denoted by the same reference numerals, and redundant description thereof will be omitted. The description will be made in the following order.
1. Background of Present Disclosure
2. Problems of Present Disclosure
3. Embodiments
3.0. Functional Block Diagram of Image Processing Apparatus
3.1. Functional Block Diagram
3.1.1. Control Information Database Generation Section 311
3.1.2. Number-of-Slices Determination Section 312
3.1.3. Parallelization Method Combination Determination Section 313
3.1.3.1. Estimation of Amount of Processing A(n) of Each Slice
3.1.3.2. Determination of Parallelization Methods in Each Slice {W(n), P(n), M(n)}
3.1.3.2.1. Calculation of Adjustment Weight
3.1.3.2.2. Pattern Adjustment with Respect to Speed Value
3.1.3.2.3. Pattern Adjustment with Respect to Number of Execution Cores
3.2. Description of Operation
3.2.1. Flowchart of Overall Processing
3.2.2. Flowchart of Generation of Control Information Database 321
3.2.3. Flowchart of Determination of Number of Slices (S)
3.2.4. Flowchart of Determination of Combination of Parallelization Methods in Each Slice [W(n), P(n), M(n)]
3.2.5. Flowchart of Case of Estimating Amount of Processing A(n) on Basis of Past Frame
3.2.6. Flowchart of Case of Estimating Amount of Processing A(n) on Basis of Feature Amount of Original Image or ME
3.2.7. Flowchart of Case of Determining Parallelization Methods in Each Slice {W(n), P(n), M(n)} on Basis of Amount of Processing A(n)
3.2.8. Flowchart of Adjustment of Parallelization Method Pattern in nth Slice with Respect to Speed Value
3.2.9. Flowchart of Parallelization Method Pattern Adjustment for Each Slice with Respect to Number of Execution Cores
4. Use Case
5. Hardware Configuration

### 1. BACKGROUND OF PRESENT DISCLOSURE

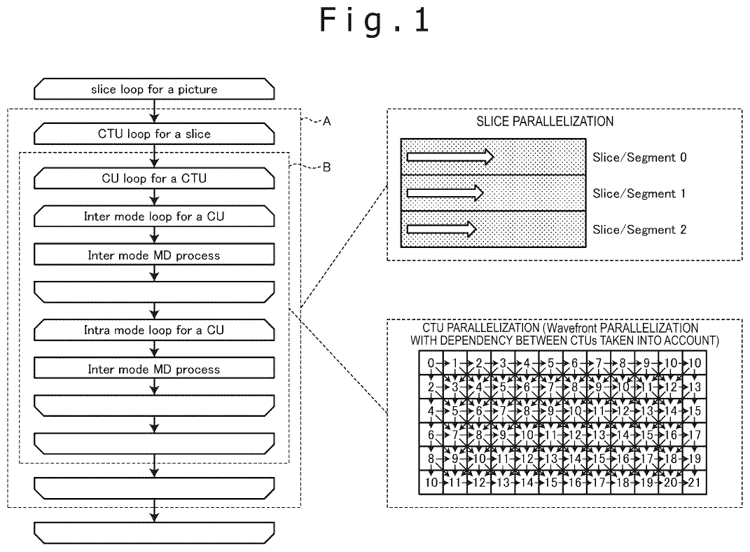

FIG. 1 is a diagram for describing an example of processing of a codec method using slice parallelization and CTU parallelization. FIG. 1 illustrates processing granularity of each parallelization method from a processing flow. As illustrated in FIG. 1, slice parallel processing is performed in a block A. Then, CTU parallel processing is performed in the processing in the block A. The CTU parallel processing is wavefront parallel processing that takes into account dependency among CTUs.

In processing of a known codec, a known parallelization method can meet speed requirements of general applications. However, VVC involves an enormous amount of processing to increase the speed of codec processing, thus requiring parallelization the degree of which is higher than in the known codec processing. In order to obtain a higher degree of parallelization, a parallelization method with a smaller processing granularity needs to be introduced.

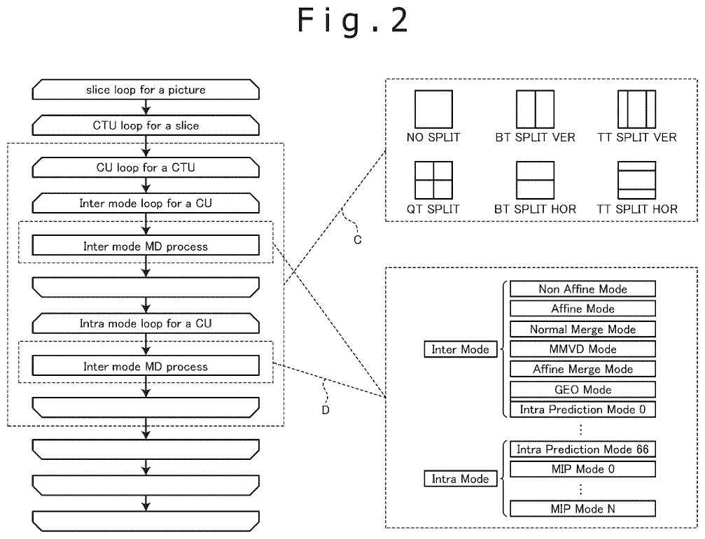

Fine-grained parallelization methods introduced to solve the parallel processing requirement of VVC may include CU partition parallelization and CU mode parallelization. FIG. 2 is a diagram for describing an example of processing of a codec method using CU partition parallelization and CU mode parallelization. FIG. 2 illustrates processing granularity of each parallelization method from a processing flow. In FIG. 2, a block C illustrates CU partition parallel processing. A block D illustrates CU mode parallel processing.

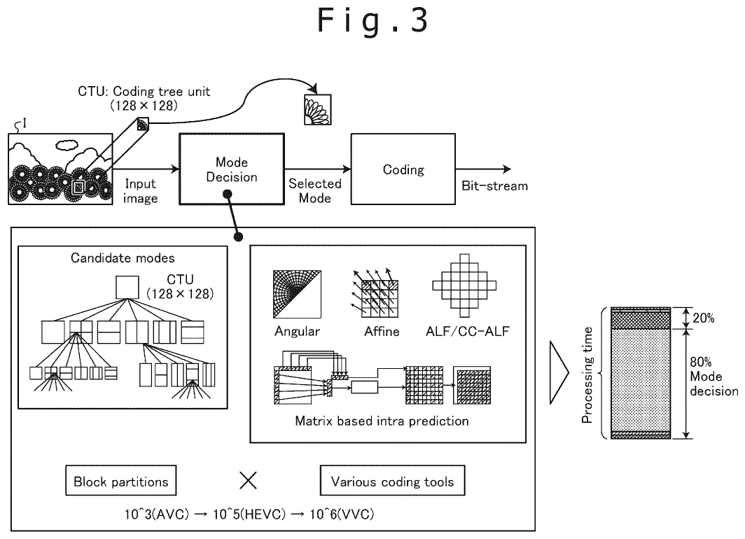

FIG. 3 is a diagram for describing an enormous amount of mode decision processing of a VVC encoder. As illustrated in FIG. 3, when an input image I including CTUs is input, mode decision processing is performed.

In the mode decision processing, block partition processing and various types of coding processing are performed. The amount of processing required is 10\hat{ }3 for Advanced Video Coding (AVC) and 10\hat{ }5 for High Efficiency Video Coding (HEVC), whereas VVC involves an enormous amount of processing of 10\hat{ }6.

As illustrated in FIG. 3, the processing time of mode decision accounts for 80% or more of the processing time of VVC encoder. Therefore, parallel processing in mode decision needs to be further improved to clear the requirement of reduction of the processing time.

Mode decision processing accounts for more than 80% of the amount of processing of the VVC encoder, and thus the present disclosure describes a parallelization method in mode decision processing.

Parallelization methods for a codec include parallelization methods such as an inter frame task pipeline, parallelization of non-reference frames, and division encoding, whereas the present disclosure is a method related to intra-frame parallelization that requires no frame delay.

### 2. PROBLEMS OF PRESENT DISCLOSURE

In the implementation of the VVC encoder, combination of various parallelization methods poses the following problems.
Basically, in parallel processing, decreasing parallelization granularity relatively increases processing overhead while reducing an increase in speed. This is due to an increased number of synchronization control operations (data copy, waiting for completion, assignment to a thread, activation of processing, and the like). Therefore, with the same number of parallel operations, the following rank basically applies to the effect of increasing the speed: slice parallelization>CTU parallelization (WPP)>CU partition parallelization>CU mode parallelization.

However, with a small number of CTU lines with which CTU parallelization (WPP) is performed, the following rank may apply: CTU parallelization (WPP)<CU partition parallelization or CTU parallelization (WPP)<CU mode parallelization. The degree of parallelization of the CTU parallelization (WPP) depends on the number of CTU lines (see FIG. 1).
For the effect of each parallelization method on coding performance, the coding performance degrades with an increasing number of parallel operations of slice parallelization (=an increasing number of slices). The coding performance basically remains unchanged among the CTU parallelization (MD WPP), the CU partition parallelization, and the CU mode parallelization.

Note that the MD WPP is a processing method in which only a mode decision section is subjected to WPP parallel processing and therefore in which an output stream is not changed by turning ON/OFF the MD WPP, with the coding performance remaining unchanged.

Problem to Be Dealt with in Combining Various Parallelization Methods

There are many variations in processing resources (instance type or the number of CPU cores), and the combination of parallelization methods needs to be optimized on the basis of the number of execution cores, the required coding performance, and the required speed according to the requirements.

### 3. EMBODIMENTS

### 3.0. Block Diagram of Image Processing Apparatus Image Encoding Apparatus

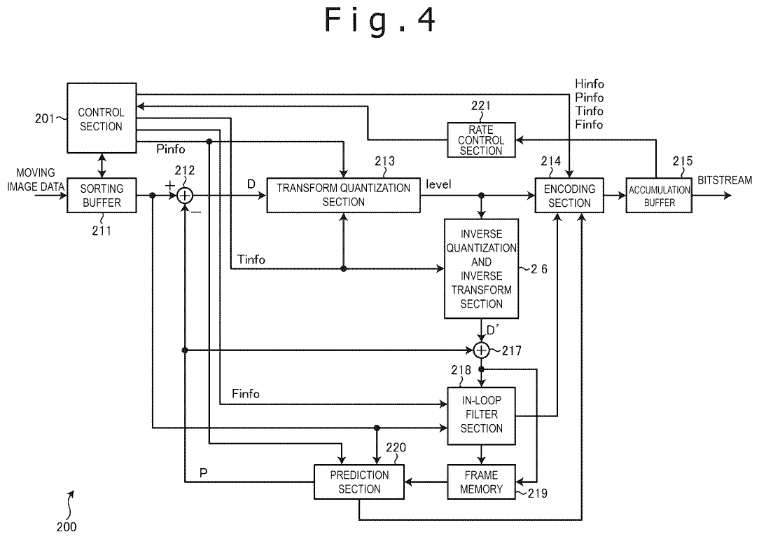

FIG. 4 is a block diagram illustrating an example of a configuration of an image encoding apparatus that is an aspect of an image processing apparatus according to an embodiment. An image encoding apparatus 200 illustrated in FIG. 4 is an apparatus that encodes image data of a moving image. For example, the image encoding apparatus 200 encodes the image data of the moving image by a coding scheme such as Versatile Video Coding (VVC), Advanced Video Coding (AVC), or High Efficiency Video Coding (HEVC).

Note that FIG. 4 illustrates main processing sections, main data flows, and the like, and not all of the processing sections, data flows, and the like. In other words, in the image encoding apparatus 200, there may be a processing section that is not illustrated as a block in FIG. 4, or a flow of processing or data that is not illustrated as an arrow or the like in FIG. 4. This also applies to other drawings for describing the processing sections and the like in the image encoding apparatus 200.

As illustrated in FIG. 4, the image encoding apparatus 200 includes a control section 201, a sorting buffer 211, a computation section 212, a transform quantization section 213, an encoding section 214, and an accumulation buffer 215. The image encoding apparatus 200 also includes an inverse quantization and inverse transform section 216, a computation section 217, an in-loop filter section 218, a frame memory 219, and a prediction section 220.

### Control Section

Based on a block size of a processing section designated externally or in advance, the control section 201 partitions moving image data held by the sorting buffer 211 into blocks (CU, PU, TU, and the like), each being a unit of processing. Additionally, the control section 201 determines coding parameters (header information Hinfo, prediction mode information Pinfo, transform information Tinfo, filter information Finfo, and the like) to be supplied to each block, for example, on the basis of rate-distortion optimization (RDO).

For example, the control section 201 sets a quantization value for a frame, sets a quantization value for a CTU (CTU baseQp), sets the coding mode (for example, mts_idx, lfnst_idx, or the like), or corrects the quantization value for each CU on the basis of subjective image quality (for example, sets CU Qp).

In the control section that determines the coding parameters (header information Hinfo, prediction mode information Pinfo, transform information Tinfo, filter information Finfo, and the like) to be supplied to each block, a mode decision module retrieves an optimal mode mainly from the viewpoint of maximized coding efficiency. Specifically, the mode decision module searches for a partition pattern of the CTU and retrieves an optimal coding mode in the partitioned CTU.

Upon determining the coding parameters as described above, the control section 201 supplies the coding parameters to each block. For example, the header information Hinfo is supplied to each block. The prediction mode information Pinfo is supplied to the encoding section 214 and the prediction section 220. The transform information Tinfo is supplied to the encoding section 214, the transform quantization section 213, and the inverse quantization and inverse transform section 216. The filter information Finfo is supplied to the encoding section 214 and the in-loop filter section 218. Of course, the supply destination of each coding parameter is optional, while not limited to this example.

For example, the control section 201 supplies set quantization values (for example, CTU baseQp, CU Qp, or the like) and control parameters for coefficient transform (for example, mts_idx, lfnst_idx, and the like) to the transform quantization section 213, the encoding section 214, and the like.

### Sorting Buffer

The image encoding apparatus 200 receives fields (input images) of moving image data in the order of reproduction (display). The sorting buffer 211 acquires and holds (stores) the input images in the order of reproduction (display). The sorting buffer 211 sorts, under the control of the control section 201, the input image in the order of encoding (decoding) or partitions the input image into blocks, each being a unit of processing. The sorting buffer 211 supplies each of the processed input images to the computation section 212.

### Computation Section

The computation section 212 subtracts a predicted image P supplied from the prediction section 220 from an image corresponding to blocks of processing units supplied from the sorting buffer 211 to derive residual data D, and supplies the residual data D to the transform quantization section 213.

### Transform Quantization Section

The transform quantization section 213 acquires the residual data D supplied from the computation section 212. The transform quantization section 213 acquires the prediction mode information Pinfo and the transform information Tinfo supplied from the control section 201. The transform quantization section 213 executes transform quantization processing on the residual data D on the basis of the prediction mode information Pinfo and the transform information Tinfo to derive a quantization coefficient level. The transform quantization processing includes executing, for example, processing such as coefficient transform (primary transform or secondary transform) or quantization. Of course, the transform quantization processing may include any processing, and part of the above-described processing may be omitted, or processing other than the above-described processing may be included. The transform quantization section 213 supplies the derived quantization coefficient level to the encoding section 214 and the inverse quantization and inverse transform section 216.

### Encoding Section

The encoding section 214 acquires the quantization coefficient level supplied from the transform quantization section 213. Additionally, the encoding section 214 acquires various encoding parameters (header information Hinfo, prediction mode information Pinfo, transform information Tinfo, filter information Finfo, and the like) supplied from the control section 201. Further, the encoding section 214 acquires information regarding a filter such as a filter coefficient supplied from the in-loop filter section 218. Additionally, the encoding section 214 also acquires information about the optimal prediction mode supplied from the prediction section 220.

The encoding section 214 performs entropy encoding (lossless encoding) on the quantization coefficient level to generate a bit string (encoded data). The encoding section 214 may apply, for example, Context-based Adaptive Binary Arithmetic Code (CABAC) as the entropy encoding. The encoding section 214 may apply, for example, Context-based Adaptive Variable Length Code (CAVLC) as the entropy encoding. Of course, the content of the entropy encoding is optional, and is not limited to the above-described examples.

The encoding section 214 derives residual information Rinfo from the quantization coefficient level, and encodes the residual information Rinfo to generate a bit string.

Further, the encoding section 214 includes, in the filter information Finfo, information regarding the filter supplied from the in-loop filter section 218, and includes, in the prediction mode information Pinfo, information regarding the optimum prediction mode supplied from the prediction section 220. Then, the encoding section 214 encodes the various encoding parameters described above (the header information Hinfo, the prediction mode information Pinfo, the transform information Tinfo, the filter information Finfo, and the like) to generate a bit string.

The encoding section 214 multiplexes bit strings of various types of information generated as described above to generate encoded data. The encoding section 214 supplies the encoded data to the accumulation buffer 215.

### Accumulation Buffer

The accumulation buffer 215 temporarily holds the encoded data obtained in the encoding section 214. The accumulation buffer 215 outputs, at a predetermined timing, the held encoded data to the outside of the image encoding apparatus 200 as, for example, a bitstream or the like. For example, the encoded data is transmitted to the decoding side via any recording medium, any transmission medium, any information processing apparatus, or the like. That is, the accumulation buffer 215 is also a transmission section that transmits encoded data (bitstream).

Note that information of the code amount of the encoded data accumulated in the accumulation buffer 215 is supplied to the control section 201. On the basis of the above-described information, the control section 201 controls the rate of the quantization operation of the transform quantization section 213 to prevent overflow or underflow.

### Inverse Quantization and Inverse Transform Section

The inverse quantization and inverse transform section 216 acquires the quantization coefficient level supplied from the transform quantization section 213. The inverse quantization and inverse transform section 216 acquires the transform information Tinfo supplied from the control section 201.

The inverse quantization and inverse transform section 216 executes inverse quantization and inverse transform processing on the quantization coefficient level on the basis of the transform information Tinfo, to derive residual data D′. This inverse quantization and inverse transform processing is inverse processing of the transform quantization processing executed in the transform quantization section 213. In other words, in the inverse quantization and inverse transform processing, for example, processing such as inverse quantization and inverse coefficient transform is executed. This inverse quantization is an inverse processing of the quantization executed in the transform quantization section 213. The inverse coefficient transform is inverse processing of the coefficient transform executed by the transform quantization section 213.

Of course, the processing included in the inverse quantization and inverse transform processing is optional, and some of the above-described processing may be omitted, or processing other than the above-described processing may be included. The inverse quantization and inverse transform section 216 supplies the derived residual data D′ to the computation section 217.

### Computation Section

The computation section 217 acquires the residual data D′ supplied from the inverse quantization and inverse transform section 216 and the predicted image P supplied from the prediction section 220. The computation section 217 adds the residual data D′ and the predicted image P corresponding to the residual data D′ to derive a local decoded image. The computation section 217 supplies the derived local decoded image to the in-loop filter section 218 and the frame memory 219.

### In-Loop Filter Section

The in-loop filter section 218 acquires the local decoded image supplied from the computation section 217. Additionally, the in-loop filter section 218 acquires the filter information Finfo supplied from the control section 201. Further, the in-loop filter section 218 acquires the input image (original image) supplied from the sorting buffer 211. Note that the information input to the in-loop filter section 218 is optional, and information other than these pieces of information may be input. For example, the in-loop filter section 218 may receive, as necessary, information such as a prediction mode, motion information, a code amount target value, a quantization parameter qP, a picture type, and a block (CU, CTU, or the like).

On the basis of the filter information Finfo, the in-loop filter section 218 executes filter processing on the local decoded image as appropriate. The in-loop filter section 218 uses the input image (original image) and other input information for the filter processing as necessary.

For example, the in-loop filter section 218 may apply a bilateral filter as the filter processing. For example, the in-loop filter section 218 may apply a DeBlocking Filter (DBF) as the filter processing. For example, the in-loop filter section 218 may apply an adaptive offset filter (Sample Adaptive Offset (SAO)) as the filter processing.

For example, the in-loop filter section 218 may apply an Adaptive Loop Filter (ALF) as the filter processing. Additionally, the in-loop filter section 218 may apply a combination of a plurality of filters among the above-described filters as the filter processing. Note that which filter is applied and in which order the filters are applied are optional and can be selected as appropriate. For example, the in-loop filter section 218 applies four in-loop filters, that is, a bilateral filter, a deblocking filter, an adaptive offset filter, and an adaptive loop filter in this order as the filter processing.

Of course, the filter processing executed by the in-loop filter section 218 is optional, and is not limited to the above-described examples. For example, the in-loop filter section 218 may apply a Wiener filter or the like.

The in-loop filter section 218 supplies the frame memory 219 with the local decoded image subjected to the filter processing. Note that, for example, in a case where information related to the filter such as a filter coefficient is transmitted to the decoding side, the in-loop filter section 218 supplies the encoding section 214 with the information related to the filter.

### Frame Memory

The frame memory 219 executes processing related to storage of data related to an image. For example, the frame memory 219 acquires the local decoded image supplied from the computation section 217 and the filtered local decoded image supplied from the in-loop filter section 218, and holds (stores) the acquired images. Additionally, the frame memory 219 uses the local decoded image to reconstruct a decoded image on a per-picture basis, and holds the reconstructed decoded image (stores the reconstructed decoded image in a buffer in the frame memory 219). The frame memory 219 supplies the decoded image (or a part thereof) to the prediction section 220 in response to a request from the prediction section 220.

### Prediction Section

The prediction section 220 executes processing related to generation of a predicted image. For example, the prediction section 220 acquires the prediction mode information Pinfo supplied from the control section 201. For example, the prediction section 220 acquires the input image (original image) supplied from the sorting buffer 211. For example, the prediction section 220 acquires a decoded image (or a part thereof) read from the frame memory 219.

The prediction section 220 executes prediction processing such as inter prediction and intra prediction using the prediction mode information Pinfo and the input image (original image). In other words, the prediction section 220 refers to the decoded image as a reference image to execute prediction and motion compensation to generate the predicted image P. The prediction section 220 supplies the generated predicted image P to the computation section 212 and the computation section 217. Additionally, the prediction section 220 supplies information related to the prediction mode selected by the above processing, i.e., the optimal prediction mode, to the encoding section 214 as necessary.

### Transform Quantization Section

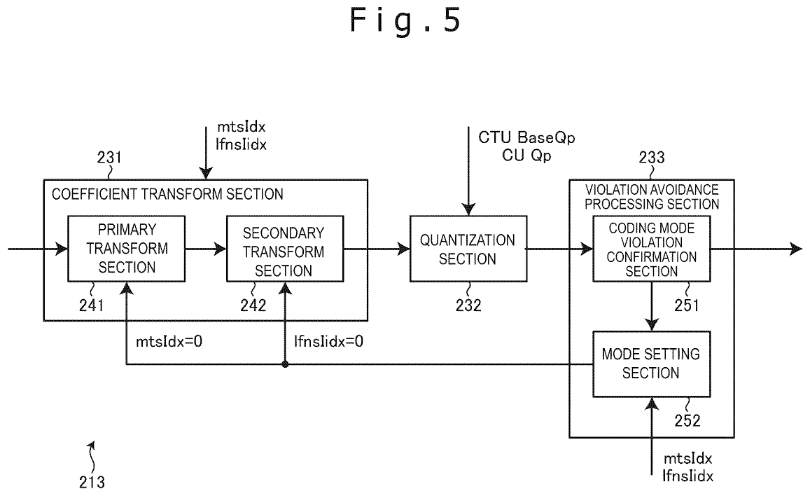

FIG. 5 is a block diagram illustrating a main configuration example of the transform quantization section 213 in FIG. 4. As illustrated in FIG. 5, the transform quantization section 213 includes a coefficient transform section 231, a quantization section 232, and a violation avoidance processing section 233.

The coefficient transform section 231 acquires prediction residuals (residual data D) supplied from the computation section 212, and executes coefficient transform on the prediction residuals to generate a transform coefficient. The coefficient transform section 231 includes a primary transform section 241 and a secondary transform section 242.

The primary transform section 241 acquires the prediction residuals (residual data D) supplied from the computation section 212 and executes primary transform on the prediction residuals to generate a primary transform coefficient. The primary transform section 241 executes primary transform in a mode according to set mts_idx. mts_idx is set by the control section 201 or the mode setting section 252 described later. For example, in the case of mts_idx>1, the primary transform section 241 applies an MTS mode to execute the primary transform. Additionally, in the case of mts_idx=0, the primary transform section 241 executes primary transform without applying the MTS mode. The primary transform section 241 supplies the generated primary transform coefficient to the secondary transform section 242.

The secondary transform section 242 acquires the primary transform coefficient supplied from the primary transform section 241, and executes secondary transform on the primary transform coefficient to generate a transform coefficient. The secondary transform section 242 executes secondary transform in a mode according to set lfnst_idx. lfnst_idx is set by the control section 201 or the mode setting section 252 described later. For example, in the case of lfnst_idx>0, the secondary transform section 242 applies an LFNST mode to execute secondary transform. Additionally, in the case of lfnst_idx=0, the secondary transform section 242 executes secondary transform without applying the LFNST mode. The secondary transform section 242 supplies the generated transform coefficient to the quantization section 232.

The quantization section 232 acquires the transform coefficient supplied from the coefficient transform section 231 (secondary transform section 242) and executes quantization on the transform coefficient to generate a quantization coefficient. The quantization section 232 executes quantization using the quantization value (CTU baseQp, CU Qp, or the like) set by the control section 201. For example, the quantization section 232 executes quantization using CTU baseQp when the control section 201 sets a coding mode. Additionally, in a case where the quantization value is corrected at the CU level, the quantization section 232 executes quantization using CU Qp.

The quantization section 232 supplies the generated quantization coefficient to the violation avoidance processing section 233. The violation avoidance processing section 233 acquires the quantization coefficient supplied from the quantization section 232, and in a case where the quantization coefficient violates a constraint on the coding mode, executes processing for avoiding the constraint violation. The violation avoidance processing section 233 includes a coding mode violation confirmation section 251 and a mode setting section 252.

The coding mode violation confirmation section 251 acquires the quantization coefficient supplied from the quantization section 232, and determines whether the quantization coefficient violates the constraint on the coding mode. For example, the coding mode violation confirmation section 251 determines whether the MTS mode is applied in the primary transform or the LFNST mode is applied in the secondary transform, and whether non-zero quantization coefficients are only DC coefficients. For example, upon determining that the LFNST mode is applied in the secondary transform and that the non-zero quantization coefficients are only the DC coefficients, the coding mode violation confirmation section 251 determines that the coding mode violation has occurred. Additionally, upon determining that the MTS mode is applied in the primary transform and that the non-zero quantization coefficients are only the DC coefficients, the coding mode violation confirmation section 251 determines that a coding mode violation has occurred.

Then, in a case where the constraint is determined to be violated, the coding mode violation confirmation section 251 supplies the mode setting section 252 with information notifying the violation. Additionally, in a case where the constraint is determined to not be violated, the coding mode violation confirmation section 251 supplies the quantization coefficient to the encoding section 214 and the inverse quantization and inverse transform section 216.

The mode setting section 252 acquires information indicating the result of the coding mode violation check by the coding mode violation confirmation section 251. The mode setting section 252 sets (updates) the coding mode on the basis of the information (that is, on the basis of the result of the coding mode violation confirmation provided by the coding mode violation confirmation section 251). For example, the mode setting section 252 controls application or non-application of the MTS mode or the LFNST mode. That is, the mode setting section 252 sets (updates) mts_idx and lfnst_idx. The mode setting section 252 supplies the set (updated) control parameters (mts_idx and lfnst_idx) to the coefficient transform section 231, and causes the coefficient transform section 231 to execute the coefficient transform again. The coefficient transform section 231 executes coefficient transform in accordance with the set (updated) control parameters. In other words, the coefficient transform and the quantization are executed again (these processing operations are reperformed).

For example, in a case where the coding mode violation confirmation section 251 determines that the LFNST mode is applied in the secondary transform and that the non-zero quantization coefficients are only the DC coefficients, the mode setting section 252 sets the control parameter specifying the mode of the secondary transform (lfnst_idx) to a value (0) at which the LFNST mode is not applied in the secondary transform. Then, the mode setting section 252 supplies the control parameter (lfnst_idx=0) to the secondary transform section 242. The secondary transform section 242 executes the secondary transform again in accordance with the control parameter (lfnst_idx=0). In other words, the secondary transform and the quantization are reperformed.

For example, in a case where the coding mode violation confirmation section 251 determines that the MTS mode is applied in the primary transform and that the non-zero quantization coefficients are only the DC coefficients, the mode setting section 252 sets the control parameter specifying the mode of the primary transform (mts_idx) to a value (0) at which the MTS mode is not applied in the primary transform. Then, the mode setting section 252 supplies the control parameter (mts_idx=0) to the primary transform section 241. The primary transform section 241 executes the primary transform again in accordance with the control parameter (mts_idx=0). In other words, the primary transform, the secondary transform, and the quantization are reperformed.

With such a configuration, the image encoding apparatus 200 can suppress violation of the constraint on the coding mode.

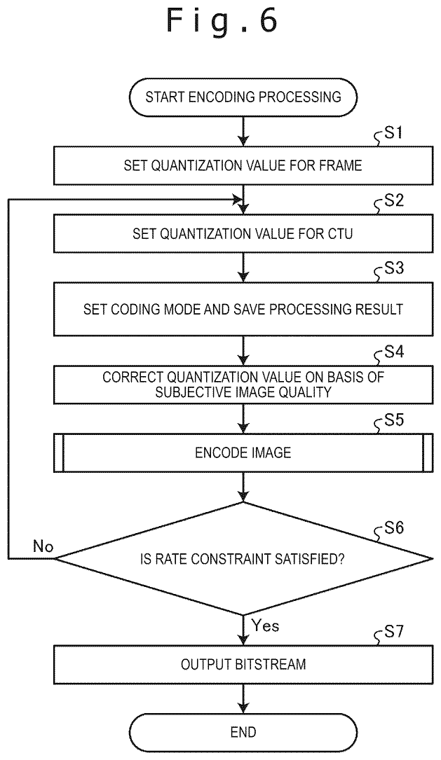

Flow of Encoding Processing Now, an example of a flow of encoding processing executed by the image encoding apparatus 200 as described above will be described with reference to a flowchart of FIG. 6.

When the encoding processing is started, the control section 201 of the image encoding apparatus 200 sets a quantization value for a frame in step S1. The control section 201 performs allocation of the amount of coding on a per-frame (picture) basis on the basis of the prediction of the amount of code generated and the feedback control so as to satisfy a constraint on a target bit rate, and determines the quantization value at the frame (picture) level.

In step S2, the control section 201 sets the quantization value for the CTU. The control section 201 partitions a frame into CTUs and determines a quantization value CTU BaseQp for each CTU. The control section 201 predicts the amount of code generated in the entire frame from the amount of code generated on a per-CTU basis, and sets CTU BaseQp so as to satisfy the constraint on the target bit rate.

In step S3, the control section 201 sets the coding mode and stores the processing result. The control section 201 determines the partition pattern of the CU (QT/BT/TT), the prediction mode (intra or inter), the mode of coefficient transform on prediction residuals (MTS, LFNST, or the like), and the like so as to obtain optimal coding efficiency under the constraint of the given quantization value (CTU BaseQp). The processing on a per-CTU basis can be sequentially executed. The processing can be executed in parallel.

In step S4, the control section 201 corrects the quantization value on the basis of the subjective image quality. The control section 201 corrects the quantization value on the basis of the feature amount of the original image such as activity in units of CU blocks obtained by partitioning the frame at the CTU level or lower in order to improve subjective image quality. In other words, the control section 201 derives the quantization value CU Qp for each CU.

In step S5, each processing section of the image encoding apparatus 200 executes image encoding processing, and encodes an image input to the image encoding apparatus 200 to generate a bitstream.

In step S6, the control section 201 determines whether the bitstream obtained in step S5 satisfies a rate constraint. In a case where the control section 201 determines that the rate constraint is not satisfied, the processing returns to step S2 to repeat the subsequent processing. In a case where the control section 201 determines in step S6 that the bitstream satisfies the rate constraint, the processing proceeds to step S7.

In step S7, the accumulation buffer 215 outputs the bitstream held by the accumulation buffer 215 to the outside of the image encoding apparatus 200. The output bitstream may be transmitted to the decoding apparatus via, for example, any transmission path, another apparatus, or the like. Additionally, the output bitstream may be recorded on any recording medium. When the processing in step S7 is completed, the encoding processing is completed.

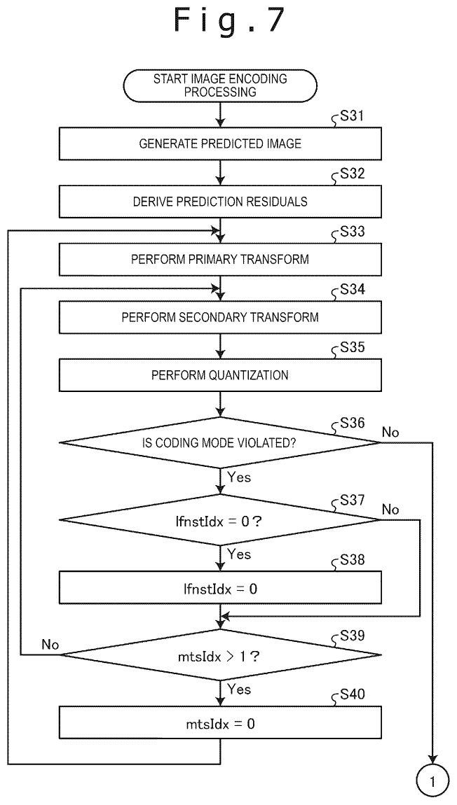

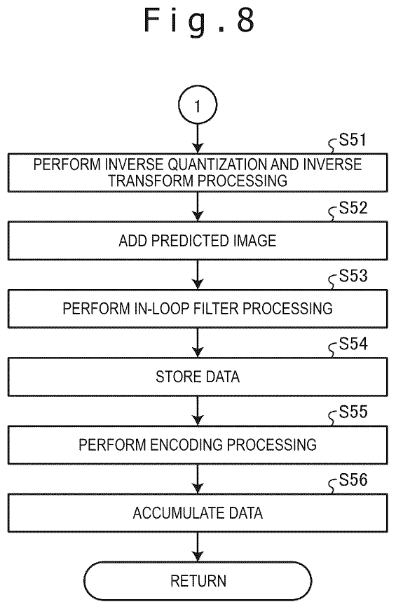

Flow of Image Encoding Processing Now, an example of the flow of the image encoding processing executed in step S5 of FIG. 6 will be described with reference to the flowcharts of FIGS. 7 and 8.

When the image encoding processing is started, the prediction section 220 generates, in step S31 in FIG. 7, a predicted image in the optimal prediction mode (intra prediction or inter prediction) set in step S3.

In step S32, the computation section 212 derives differences (prediction residuals) between the input image and the predicted image generated in step S31. In other words, the computation section 212 derives residual data D between the input image and the predicted image. The residual data D derived in this manner has a reduced data amount compared to the original image data. Therefore, the data amount can be compressed compared with a case where the image is directly encoded without any change.

In step S33, the primary transform section 241 executes primary transform on the prediction residuals in the mode of coefficient transform set in step S3 (the mode indicated by mts_idx) to generate a primary transform coefficient.

In step S34, the secondary transform section 242 performs the secondary transform on the primary transform coefficient in the mode of coefficient transform set in step S3 (the mode indicated by lfnst_idx) to generate a transform coefficient.

In step S35, the quantization section 232 uses the quantization value (CU Qp) corrected in step S4 to execute quantization on the transform coefficient generated in step S34, thereby generating a quantization coefficient.

In step S36, the coding mode violation confirmation section 251 determines whether the quantization coefficient generated in step S35 violates the constraint on the coding mode. In a case where the coding mode is determined to be violated, the processing proceeds to step S37.

In step S37, the coding mode violation confirmation section 251 determines whether the LFNST mode has been applied in the secondary transform (lfnstIdx>0). In a case where the LFNST mode is determined to have been applied (lfnstIdx>0), the processing proceeds to step S38.

In step S38, the mode setting section 252 sets lfnstIdx to 0 (lfnstIdx=0). When the processing in step S38 is completed, the processing proceeds to step S39. On the other hand, in a case, in step S37, the LFNST mode is determined not to have been applied in secondary transform (lfnstIdx=0), the processing advances to step S39.

In step S39, the coding mode violation confirmation section 251 determines whether the MTS mode has been applied in the primary transform (mtsIdx>1). In a case where the MTS mode is determined not to have been applied, the processing returns to step S34 to execute the subsequent processing. In other words, in this case, the secondary transform and the quantization are reperformed.

Additionally, in a case where, in step S39, the MTS mode is determined to have been applied (mtsIdx>1), the processing proceeds to step S40.

In step S40, the mode setting section 252 sets the mtsIdx to 0 (mtsIdx=0). When the processing in step S40 is completed, the processing returns to step S33 to execute the subsequent processing. In other words, in this case, the primary transform, the secondary transform, and the quantization are reperformed.

Additionally, in step S36, in a case where the quantization coefficient is determined not to violate the constraint on the coding mode, the processing proceeds to FIG. 8.

In step S51 in FIG. 8, the inverse quantization and inverse transform section 216 performs inverse quantization and inverse transform on the quantization coefficient generated in step S35, to derive (restore) prediction residuals (residual data D′).

In the step S52, the computation section 217 adds the predicted image generated in step S31 to the residual data D′ derived by the inverse quantization and inverse transform processing in step S51, thereby generating a decoded image that is locally decoded.

In step S53, the in-loop filter section 218 executes in-loop filter processing on the locally decoded image generated in step S52.

In step S54, the frame memory 219 stores the locally decoded image generated in step S52 and the locally decoded image filtered in step S53.

In step S55, the encoding section 214 encodes the quantization coefficient level generated in step S35 to generate a bitstream. Additionally, at this time, the encoding section 214 can encode any information other than the quantization coefficient and store the encoded information in the bitstream. For example, the encoding section 214 may encode various coding parameters (header information Hinfo, prediction mode information Pinfo, transform information Tinfo, and the like) and store the encoded data in a bitstream. Additionally, the encoding section 214 may derive the residual information RInfo from the quantization coefficient level, encode the residual information RInfo and the like, and store the encoded data in the bitstream.

In step S56, the accumulation buffer 215 accumulates the bitstream derived as described above, and outputs the bitstream to the outside of the image encoding apparatus 200 at a predetermined timing or on the basis of a request from another apparatus or the like. The bitstream is transmitted to a decoding apparatus or the like via a transmission path or a recording medium, for example. When the processing in step S56 is completed, the image encoding processing is completed, and the processing returns to FIG. 6.

### 3.1 Functional Block Diagram

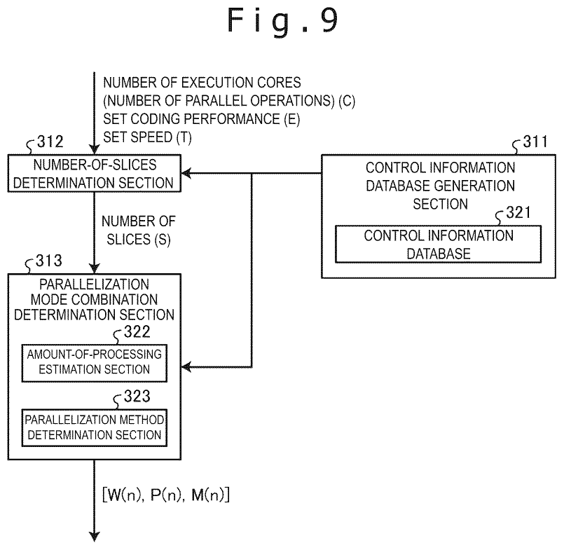

FIG. 9 is a functional block diagram illustrating functionals of a VVC encoder 310 according to an embodiment. The VVC encoder 310 of FIG. 9 is implemented as a function of the control section 201 illustrated in FIG. 8. As illustrated in FIG. 9, the VVC encoder 310 includes a control information database generation section 311, a number-of-slices determination section 312, and a parallelization method combination determination section 313. The embodiment assumes a software encoder that operates on any operating system or a hardware encoder having similar functions.

### 3.1.1 Control Information Database Generation Section 311

The control information database generation section 311 includes a control information database 321. The control information database generation section 311 generates a control information database 321 including the number of slices (S) in the CTU, coding performance (E) with respect to the number of slices, a speed value (T) having a plurality of speed patterns with respect to the number of slices, and the number of execution cores (the number of parallel operations) (C) having a plurality of patterns of the number of execution cores with respect to the plurality of speed patterns.

Each of the plurality of speed value patterns in the control information database 321 has a combination of the number of CTU parallel operations W(n) and the number of CU partition parallel operations (the number of parallel operations P(n) and the number of CU mode parallel operations M(n)) according to the plurality of speed value patterns.

The control information database generation section 311 statistically obtains the control information database 321 (for example, an actually measured average value of sample data).

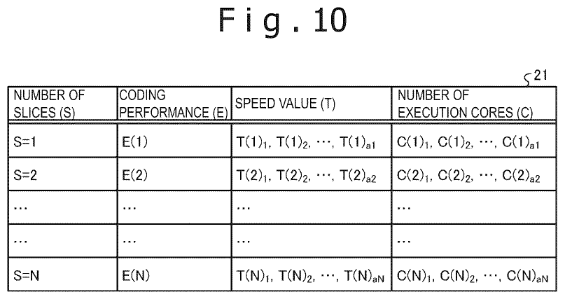

FIG. 10 is a diagram illustrating the control information database 321 according to an embodiment. Note that FIG. 10 does not illustrate the combination of the number of CTU parallel operations W(n) and the number of CU partition parallel operations (the number of parallel operations P(n) and the number of CU mode parallel operations M(n)) according to the plurality of speed value patterns.

In FIG. 10, the parameters are described as follows.
a1, a2, . . . , aN: the number of parallelization method combination patterns when the number of slices ranges from 1 to N
T(N)₁, T(N)₂, . . . , T(N)a_{N}: speed values in various parallelization method combination patterns when the number of slices is N; T(N)₁<T(N)₂< . . . <T(N)_{aN}.
C(N)₁, C(N)₂, . . . , C(N)_{aN}: the number of execution cores (the number of parallel operations) in various parallelization method combination patterns when the number of slices is N; C(N)₁<C(N)₂< . . . , <C(N)_{aN}.
E(1)>E(2)> . . . , E(N)

### 3.1.2 Number-of-Slices Determination Section 312

The number-of-slices determination section 312 determines the number of slices based on a set number of execution cores, set coding performance, and a set speed for an input CTU to be encoded. The number-of-slices determination section 312 determines the number of slices obtained by the number-of-slices determination section 312.

Specifically, the number-of-slices determination section 312 extracts, from the control information database 321, an adoption candidate patterns that satisfy the set number of execution cores, the set coding performance, and the set speed for the CTU to be encoded, the set number of execution cores, the set coding performance, and the set speed having been input, and determines the number of slices from the extracted adoption candidate patterns.

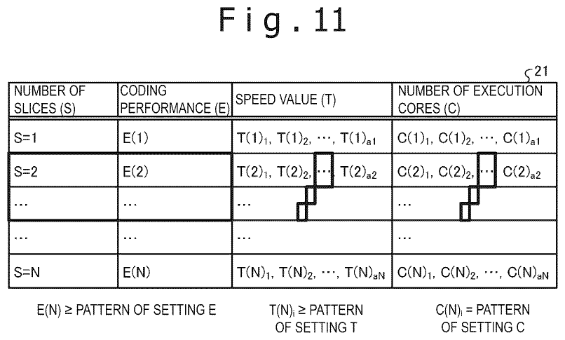

FIG. 11 is a diagram illustrating the control information database 321 for describing the determination of the number of slices by the number-of-slices determination section 312 according to an embodiment. As illustrated in FIG. 11, when the number of execution cores (the number of parallel operations) (C), the set coding performance (E), and the set speed (T) are given, the number-of-slices determination section 312 extracts patterns satisfying the respective conditions from the control information database 321, and sets patterns of C(N)=C as adoption candidates (a portion surrounded by a thick line in FIG. 11).

Next, the number-of-slices determination section 312 determines the number of slices from the adoption candidate patterns according to settings with the coding performance emphasized or the speed emphasized. All the adoption candidate patterns satisfy the set coding performance and the set speed, but vary in the coding performance and the speed. The number-of-slices determination section 312 determines the number of slices (S) by determining an adoption pattern depending on the settings with the coding performance emphasized or the settings with the speed emphasized.

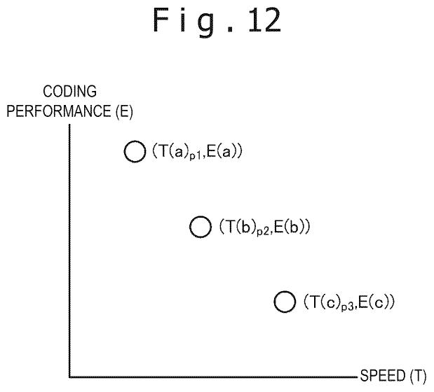

FIG. 12 is a diagram for describing determination of the coding performance and the speed by the number-of-slices determination section 312 according to an embodiment. For example, with the coding performance emphasized, the number-of-slices determination section 312 adopts (T(a)p1, E(a)) illustrated in FIG. 12, and determines the number of slices (S)=a. With the speed emphasized, the number-of-slices determination section 312 adopts (T(c)p3, E(c)) and determines the number of slices (S)=c. With balance emphasized, the number-of-slices determination section 312 adopts (T(b)p2, E(b)) and determines the number of slices (S)=b. In other words, the number-of-slices determination section 312 extracts the adoption candidate patterns depending on the settings of the coding performance and the speed.

### 3.1.3 Parallelization Method Combination Determination Section 313

As illustrated in FIG. 9, the parallelization method combination determination section 313 includes an amount-of-processing estimation section 322 and a parallelization method determination section 323. The parallelization method combination determination section 313 determines a combination of the number of CTU parallel operations (W(n)), the number of CU partition parallel operations (P(n)), and the number of CU mode parallel operations (M(n)) to be performed in each of slices the number of which is determined by the number-of-slices determination section 312.

The actual amount of processing A for each slice varies considerably. A combination of CTU parallelization (WPP) (the number of parallel operations W(n)), CU partition parallelization (the number of parallel operations P(n)), and CU mode parallelization (the number of parallel operations M(n)) to be performed in each slice, is determined according to the amount of processing (A(n)) of each slice. This improves the balance of the processing time.

### 3.1.3.1 Estimation of Amount of Processing A(n) for Each Slice

The amount-of-processing estimation section 322 estimates the amount of processing A(n) for each slice. A method for estimating the amount of processing A(n) for each slice includes, for example, the following estimation methods (1) and (2).

### (1) Estimation Based on Amount of Processing for Past Frame

This is a method of approximating the amount of processing A(n) by the degree of difficulty Complexity of encoding.

The estimation is based on A(n)=Complexity=B×Q.

Here,
B: slice coding amount for the same slice at a previous time
Q: slice quantization value for the same slice at the previous time.

### (2) Estimation Based on at Least One of Feature Amount of Original Image or Feature Amount of Motion Estimation (ME)

The estimation is based on A(n)=w1×original image feature amount+w2×ME feature amount.

Here,
original image feature amount: A(n)=the sum of original image feature amount (Variance (Var)), Mean Absolute Difference (MAD), and Total Variation (TV) for blocks in a slice,
ME feature amount: A(n)=the sum of ME feature amount (Sum of Absolute Difference (SAD)) for the blocks in the slice,
w1 is a weight for the original image feature amount value, and
w2 is a weight for the ME feature amount value.

Note that Var, MAD, TV, and SAD are generally expressed as Equations (1) to (4).

$$\begin{matrix}[ Equation 1 ] & \\ Var = \frac{1}{n} {\sum }_{n = 1}^{n} {( {x}_{i} - \overline{x} )}^{2} & ( 1 )\end{matrix}$$

$$\begin{matrix}[ Equation 2 ] & \\ MAD = \frac{1}{n} {\sum }_{i = 1}^{n} \vert {x}_{i} - \overline{x} \vert & ( 2 )\end{matrix}$$

$$\begin{matrix}[ Equation 3 ] & \\ TV = {\sum }_{i = 1}^{d} \sqrt{{( {D}_{x} y )}_{i}^{2} + {( {D}_{y} y )}_{i}^{2}} & ( 3 )\end{matrix}$$

$$\begin{matrix}[ Equation 4 ] & \\ SAD = {\sum }_{i} {\sum }_{j} \vert I ( i , j ) - T ( i , j ) \vert & ( 4 )\end{matrix}$$

### 3.1.3.2 Determination of Parallelization Methods in Each Slice {W(n), P(n), M(n)}

The parallelization method determination section 323 determines parallelization methods in each slice {W(n), P(n), M(n)} on the basis of the amount of processing A(n).

### 3.1.3.2.1 Calculation of Adjustment Weight

In order to determine the parallelization methods in each slice {W(n), P(n), M(n)}, first, adjustment Weight for the slice parallelization method is obtained from the ratio of A(n).

Weight(n)=A(n)/ΣA(n)×S, n=0,1, . . . ,S−1

For example, in the case of A(n)/ZA(n)={0.2, 0.25, 0.25, 0.3} of 4slice, Weight(n)={0.8, 1.0, 1.0, 1.2}.

### 3.1.3.2.2 Pattern Adjustment for Speed Value

Pattern adjustment for the speed value is performed by searching for a pattern close to the speed value pattern T(S)ₚ adopted in <3.1.2. Number-of-Slices Determination Section 312> on the basis of Weight (n). A speed value pattern closest to Weight(n)×T(S)ₚ is searched for.

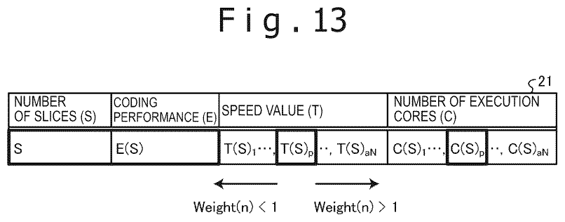

FIG. 13 is a diagram illustrating the control information database 321 for describing retrieval of the speed value T(S)ₚ by the parallelization method determination section 323 according to an embodiment. As illustrated in FIG. 13, the parallelization method determination section 323 searches toward the right (the speed increases toward the right) when Weight(n)>1, and searches toward the left (the speed decreases toward the left) when Weight(n)<1.

3.1.3.2.3 Pattern Adjustment with Respect to Number of Execution Cores

The number of execution cores for each slice is C(S)ₚ₍ₙ₎/S as a result of the parallelization method adjustment for each slice performed in <3.1.3.2.2. Pattern Adjustment with Respect to Speed Value>. Here, n=0, 1, . . . , S−1.

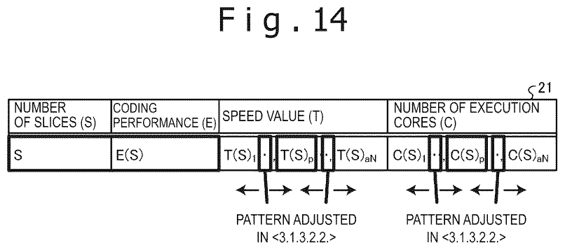

FIG. 14 is a diagram illustrating the control information database 321 for describing retrieval of the number of execution cores by the parallelization method determination section 323 according to the embodiment.

In a case where Σ(C(S)ₚ₍ₙ₎/S)>the number of execution cores (C), the parallelization method determination section 323 selects the pattern obtained by the adjustment in <3.1.3.2.2. Pattern Adjustment for Speed Value>(the pattern of the number of execution cores (C) corresponding to the pattern of the speed value (T)), shifts the pattern to the left, and readjusts the pattern in such a manner that Σ(C(S)ₚ₍ₙ₎/S)=the number of execution cores (C). In this case, the readjustment is performed by allowing preferential selection of a readjustment pattern that is close to Weight(n)×T(S)ₚ.

In a case where Σ(C(S)ₚ₍ₙ₎/S)<the number of execution cores (C), the parallelization method determination section 323 selects the pattern obtained by the adjustment in <3.1.3.2.2. Pattern Adjustment for Speed Value> and shifts the pattern to the right to readjust the pattern in such a manner that Σ(C(S)ₚ₍ₙ₎/S)=the number of execution cores (C). In this case, the readjustment is performed by allowing preferential selection of a readjustment pattern that is far from Weight(n)×T(S)ₚ (a pattern is selected that is highly effective for increasing the speed).

In other words, the parallelization method determination section 323 adjusts the pattern of the number of execution cores (C) corresponding to the searched pattern of the speed value (T) to the input set number of execution cores based on the determined number of slices.

### 3.2. Description of Operation

### 3.2.1 Flowchart of Overall Processing

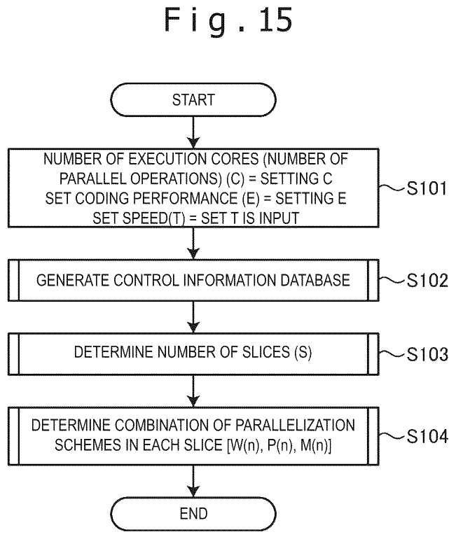

FIG. 15 is a flowchart illustrating overall processing for determining a parallel processing method of the encoder according to an embodiment.

As illustrated in FIG. 15, the number of execution cores (the number of parallel operations) (C)=the setting C, the set coding performance (E)=the setting E, and the set speed (T)=the setting T are input (step S101). Next, the control information database 321 is generated (step S102). Note that the order of processing of step S101 and step S102 may be reversed.

Next, the number of slices (S) is determined (step S103), the combination of the parallelization methods in each slice [W(n), P(n), M(n)] is determined (step S104), and the processing ends.

### 3.2.2 Flowchart of Generation of Control Information Database 321

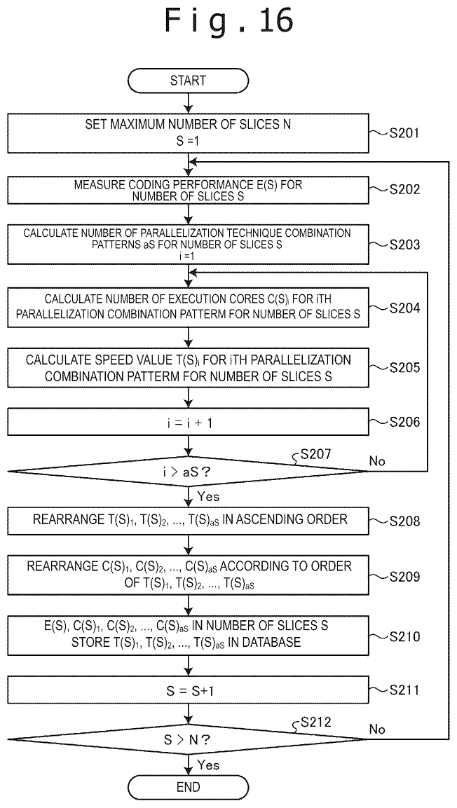

FIG. 16 is a diagram illustrating a flowchart of generation of the control information database 321 of the encoder according to an embodiment. FIG. 16 corresponds to step S102 in FIG. 15.

As illustrated in FIG. 16, the maximum slice number N is set, and S=1 is set (step S201). Then, the coding performance E(S) for the number of slices S is measured (step S202). Then, the number of parallelization technique combination patterns aS for the number of slices S is calculated, and i=1 is set (step S203).

Then, the number of execution cores C(S)ᵢ of the ith parallelization combination pattern in the number of slices S is calculated (step S204), and the speed value T(S)ᵢ for the ith parallelization combination pattern at the number of slices S is calculated (step S205).

Assuming that i=i+1 (step S206), whether i>aS is satisfied is determined (step S207). In step S207, in a case where i>aS is determined not to be satisfied (No in step S207), the processing returns to step S204.

In step S207, in a case where i>aS is determined to be satisfied (Yes in step S207), T(S)₁, T(S)₂, . . . , T(S)_{aS} are rearranged in ascending order (step S208), and C(S)₁, C(S)₂, . . . , C(S)_{aS} are rearranged according to the order of T(S)₁, T(S)₂, . . . , T(S)_{aS} (step S209).

Then, E(S), C(S)ᵢ, C(S)₂, . . . , C(S)_{aS}, T(S)₁, T(S)₂, . . . , T(S)_{aS} at the number of slices S are stored in the control information database 321 (step S210), S=S+1 is set (step S211), and whether S>N is satisfied is determined (step S212).

In step S212, in a case where S>N is satisfied (Yes in step S212), the processing of generating the control information database 321 is ended. In step S212, in a case where S>N is not satisfied (No in step S212), the processing returns to step S202.

### 3.2.3 Flowchart of Determination of Number of Slices (S)

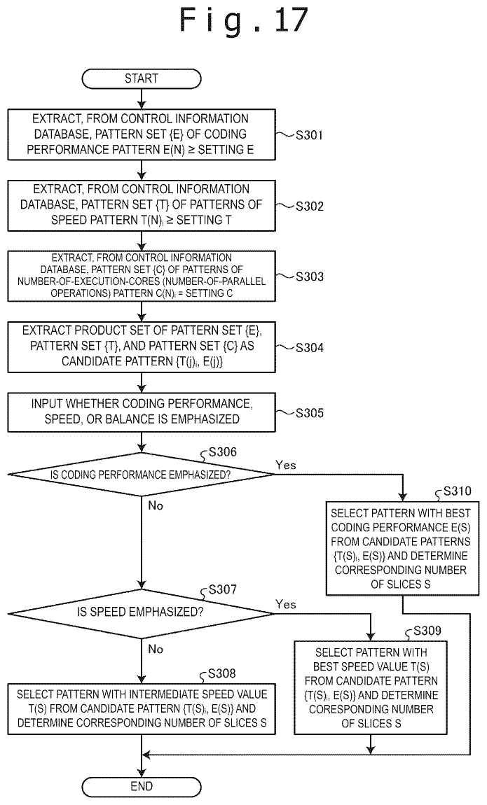

FIG. 17 is a flowchart of determination of the number of slices (S) by the encoder according to an embodiment. FIG. 17 corresponds to step S103 in FIG. 15.

As described in S101 of FIG. 15, the number of execution cores (the number of parallel operations) (C)=the setting C, the set coding performance (E)=the setting E, and the set speed (T)=the setting T are input. As illustrated in FIG. 17, a pattern set {E} of the coding performance pattern E(N)≥setting E is extracted from the control information database 321 (step S301).

Then, a pattern set {T} of patterns of the speed pattern T(N)ᵢ≥the setting T is extracted from the control information database 321 (step S302), and a pattern set {C} of patterns of the number-of-execution-cores (number-of-parallel-operations) pattern C(N)ᵢ=the setting C is extracted from the control information database 321 (step S303).

Then, a product set of the pattern set {E}, the pattern set {T}, and the pattern set {C} is extracted as candidate patterns {T(j)ᵢ, E(j)} (step S304). Then, whether the coding performance, the speed, or the balance is emphasized is input (step S305).

Then, whether the coding performance is emphasized is determined (step S306), and in a case where the coding performance is emphasized (Yes in step S306), a pattern with the best coding performance E(S) is selected from the candidate patterns {T(S)ᵢ, E(S)}. The corresponding number of slices S is determined (step S310), and the processing of determining the number of slices (S) is ended.

In step S306, when the coding performance is not emphasized (No in step S306), whether the speed is emphasized is determined (step S307). In a case where the speed is emphasized (Yes in step S307), a pattern with the best speed value T(S) is selected from the candidate patterns {T(S)ᵢ, E(S)}. The corresponding number of slices S is determined (step S309), and the processing of determining the number of slices (S) is ended.

In step S307, in a case where the speed is not emphasized (No in step S307), a pattern with an intermediate speed value T(S) is selected from the candidate patterns {T(S)ᵢ, E(S)}. The corresponding number of slices S is determined (step S308), and the processing of determining the number of slices (S) is ended.

### 3.2.4 Flowchart of Determination of Combination of Parallelization Methods in Each Slice [W(n), P(n), M(n)]

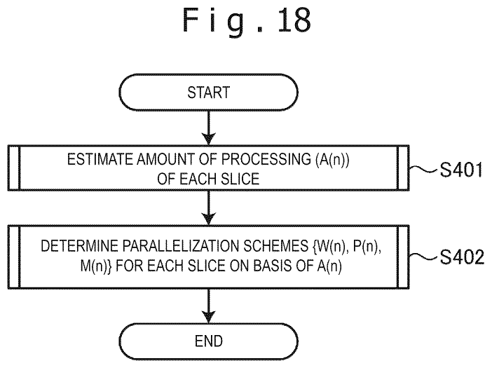

FIG. 18 is a flowchart of determination of a combination of the parallelization methods in each slice [W(n), P(n), M(n)] according to an embodiment.

As illustrated in FIG. 18, in the determination of the combination of the parallelization methods in each slice [W(n), P(n), M(n)], first, the amount of processing (A(n)) for each slice is estimated (step S401).

Then, the parallelization methods in each slice {W(n), P(n), M(n)} are determined on the basis of the amount of processing A(n) (step S402), and the processing of determining the combination of parallelization methods [W(n), P(n), M(n)] is ended (step S402).

### 3.2.5 Flowchart of Case of Estimating Amount of Processing A(n) on Basis of Past Frame

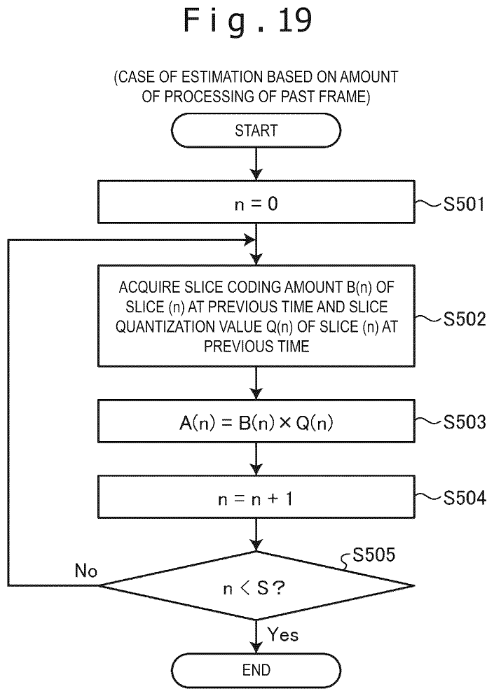

FIG. 19 is a flowchart of estimating the amount of processing A(n) based on a past frame according to an embodiment. FIG. 19 corresponds to step S401 in FIG. 18.

As illustrated in FIG. 19, first, n=0 is set (step S501), and then the slice coding amount B (n) of the slice (n) at a previous time and the slice quantization value Q (n) of the slice (n) at the previous time are acquired (step S502).

Then, the amount of processing A(n)=B(n)×Q(n) is obtained (step S503), n=n+1 is set (step S504), and whether n<S is satisfied is determined (step S505). In step S505, in a case where n<S is satisfied (Yes in step S505), the processing of estimating the amount of processing A(n) is ended. In step S505, in a case where n<S is not satisfied (No in step S505), the process returns to step S502.

### <3.2.6 Flowchart of Case of Estimating Amount of Processing A(n) on Basis of Feature Amount of Original Image or ME>

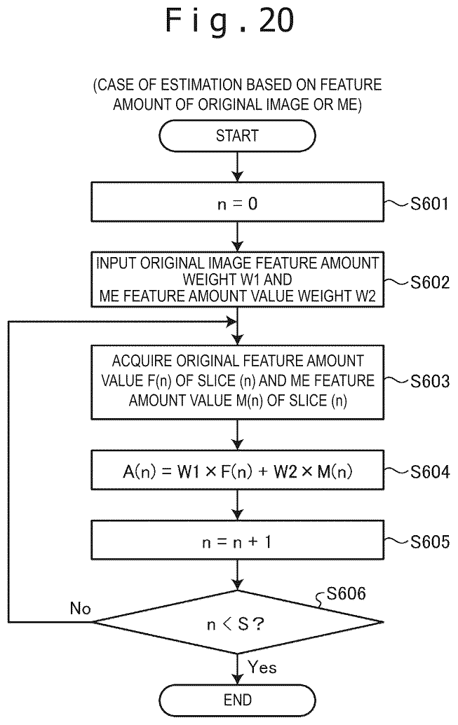

FIG. 20 is a flowchart of a case of estimating the amount of processing A(n) on the basis of the feature amount of the original image or the ME according to the embodiment. FIG. 20 corresponds to step S401 in FIG. 18.

As illustrated in FIG. 20, first, n=0 is set (step S601), and then an original image feature amount weight W1 and an ME feature amount weight W2 are input (step S602). Then, an original image feature amount value F(n) of the slice (n) and an ME feature amount value M(n) of the slice (n) are acquired (step S603).

Then, the amount of processing A(n)=W1×F(n)+W2×M(n) is calculated (step S604), n=n+1 is set (step S605), and whether n<S is satisfied is determined (step S606).

In step S606, when n<S is satisfied (Yes in step S606), the processing of estimating the amount of processing A(n) is ended. In step S606, when n<S is not satisfied (No in step S606), the processing returns to step S603.

### <3.2.7 Flowchart of Case of Determining Parallelization Methods in Each Slice {W(n), P(n), M(n)} on Basis of Processing Amount A(n)>

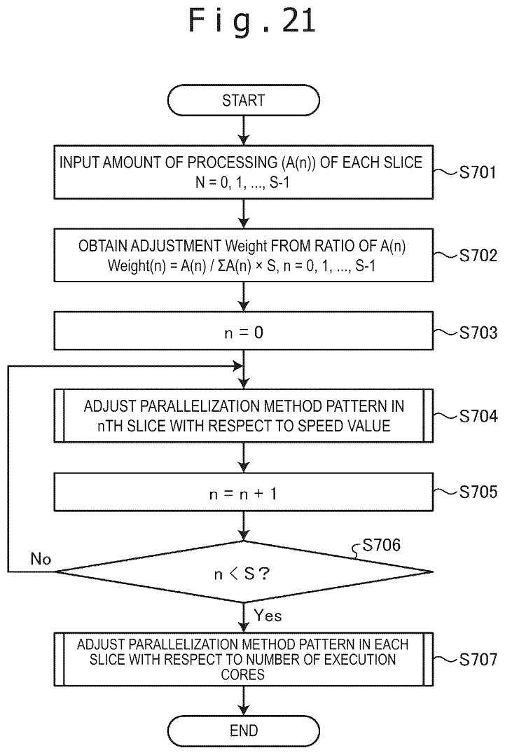

FIG. 21 is a flowchart of a case of determining the parallelization methods in each slice {W(n), P(n), M(n)} on the basis of the amount of processing A(n) according to an embodiment. FIG. 21 corresponds to step S402 in FIG. 18.

As illustrated in FIG. 21, the amount of processing (A(n)) for each slice is input (step S701). Here, n=0, 1, . . . , S−1. Then, the adjustment Weight is obtained from the ratio of A(n) (step S702). Here, Weight(n)=A(n)/ZA(n)×S, n=0, 1, . . . , S−1.

Then, n=0 is set (step S703) and the speed value of the parallelization method pattern in the nth slice is adjusted (step S704). Then, n=n+1 is set (step S705), and whether n<S is satisfied is determined (step S706).

In step S706, in a case where n<S is satisfied (Yes in step S706), the pattern of the parallelization methods for each slice is adjusted with respect to the number of execution cores (step S707), and the processing of determining the parallelization methods in each slice {W(n), P(n), M(n)} is ended. In step S706, in a case where n<S is not satisfied (No in step S706), the processing returns to step S704.

### 3.2.8. Flowchart of Adjustment of Speed Value of Parallelization Method Pattern in Nth Slice

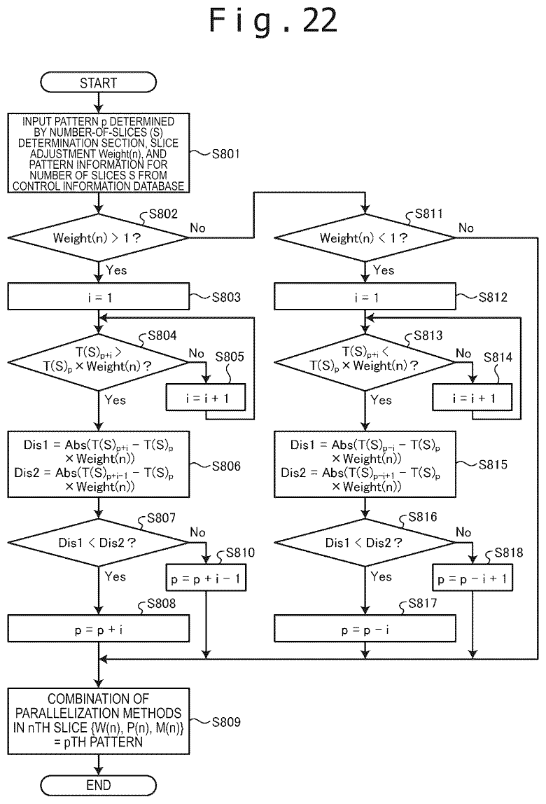

FIG. 22 is a flowchart of adjustment of the speed value of the parallelization method pattern in the nth slice according to the embodiment. FIG. 22 corresponds to step S704 in FIG. 21.

As illustrated in FIG. 22, first, the pattern p determined by the number-of-slices (S) determination section, the slice adjustment Weight(n), and the pattern information for the number of slices S from the control information database 321 are input (step S801).

Then, whether Weight(n)>1 is determined (step S802). In step S802, in a case where Weight(n)>1 is determined to be satisfied (Yes in step S802), i=1 is set (step S803), and whether T(S)ₚ₊ᵢ>T(S)ₚ×Weight(n) is satisfied is determined (step S804).

In step S804, in a case where T(S)ₚ₊ᵢ>T(S)ₚ×Weight(n) is not satisfied (No in step S804), i=i+1 is set (step S805), and the processing returns to step S804.

In step S804, in a case where T(S)ₚ₊ᵢ>T(S)ₚ×Weight(n) (Yes in step S804), Dis1=Abs(T(S)ₚ₊ᵢ−T(S)ₚ×Weight(n)) and Dis2=Abs (T(S)ₚ₊ᵢ₋₁−T(S)ₚ×Weight (n)) are obtained (step S806).

Then, whether Dis1<Dis2 is determined (step S807). In step S807, in a case where Dis1<Dis2 is determined (Yes in step S807), p=p+i is set (step S808), the combination of the parallelization methods in the nth slice {W(n), P(n), M(n)}=the pth pattern is determined (step S809), and the adjustment processing for the speed value is ended.

In step S807, in a case where Dis1<Dis2 is not satisfied (No in step S807), p=p−i is set (step S810), the combination of the parallelization methods in the nth slice {W(n), P(n), M(n)}=the pth pattern is determined (step S809), and the adjustment processing for the speed value is ended.

On the other hand, in step S802, in a case where Weight(n)>1 is determined to not be satisfied (No in step S802), whether Weight(n)<1 is satisfied is determined (step S811). In step S811, in a case where Weight(n)<1 is determined to be satisfied (Yes in step S811), i=1 is set (step S812), and whether T(S)ₚ₋ᵢ<T(S)ₚ×Weight(n) is satisfied is determined (step S813).

In step S813, in a case where T(S)ₚ₋ᵢ<T(S)ₚ×Weight(n) is determined not to be satisfied (No in step S813), i=i+1 is set (step S814), and the processing returns to step S813.

In step S813, in a case where T(S)ₚ₋ᵢ<T(S)ₚ×Weight (n) is determined to be satisfied (Yes in step S813), Dis1=Abs(T(S)ₚ₋ᵢ−T(S)ₚ×Weight (n)) and Dis2=Abs (T(S)ₚ₋ᵢ₊₁−T(S)ₚ×Weight (n)) are obtained (step S815).

Then, whether Dis1<Dis2 is satisfied is determined (step S816). In step S816, when it is determined that Dis1<Dis2 (Yes in step S816), p=p−i is set (step S817), the combination of the parallelization methods in the nth slice {W(n), P(n), M(n)}=the pth pattern is determined (step S809), and the adjustment processing for the speed value is ended.

In step S816, in a case where Dis1<Dis2 is determined not to be satisfied (No in step S816), p=p−i+1 is set (step S818), the combination of the parallelization methods in the nth slice {W(n), P(n), M(n)}=the pth pattern is determined (step S809), and the adjustment processing for the speed value is ended.

3.2.9 Flowchart of Adjustment of Parallelization Method Pattern for Each Slice with Respect to Number of Execution Cores

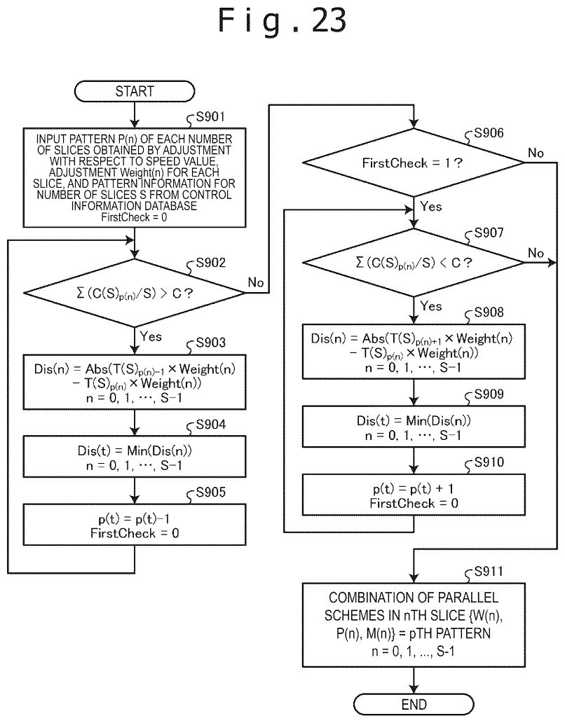

FIG. 23 is a flowchart of adjustment of the parallelization method pattern for each slice with respect to the number of execution cores.

First, the pattern p(n) for each number of slices obtained by adjustment with respect to the speed value, the adjustment Weight(n) for each slice, and the pattern information for the number of slices S from the control information database 321 are input. Additionally, FirstCheck=0 is set (step S901).

Then, whether Σ(C(S)p(n)/S)>C is satisfied is determined (step S902). In step S902, in a case where Σ(C(S)p(n)/S)>C is determined to be satisfied (Yes in step S902), Dis(n)=Abs(T(S)ₚ₍ₙ₎₋₁×Weight(n)−T(S)ₚ₍ₙ₎×Weight(n)) is set (step S903). Here, n=0, 1, . . . , S−1.

Then, Dis(t)=Min(Dis(n)) is set (step S904). Here, n=0, 1, . . . , S−1. Then, p(t)=p(t)−1 and FirstCheck=0 are set (step S905), and the processing returns to step S902.

On the other hand, in step S902, in a case where Σ(C(S)p(n)/S)>C is determined not to be satisfied (No in step S902), whether FirstCheck=1 is satisfied is determined (step S906). In step S906, when FirstCheck=1 (Yes in step S906), whether Σ(C(S)ₚ₍ₙ₎/S)<C is satisfied is determined (step S907).

In step S907, in a case where Σ(C(S)ₚ₍ₙ₎/S)<C is determined to be satisfied (Yes in step S907), Dis(n)=Abs(T(S)ₚ₍ₙ₎₊₁×Weight(n)−T(S)ₚ(n)×Weight(n)) is set (step S908). Here, n=0, 1, . . . , S−1.

Then, Dis(t)=Min(Dis (n)) is set (step S909). Here, n=0, 1, . . . , S−1. Then, p(t)=p(t)+1 and FirstCheck=0 are set (step S910), and the processing returns to step S907.

On the other hand, in step S906, in a case where FirstCheck=1 is not satisfied (No in step S906), the combination of the parallelization schemes in the nth slice {W(n), P(n), M(n)}=the pth pattern is set (step S911), and the processing of adjusting the parallelization method pattern for each slice with respect to the number of execution cores is ended. Here, n=0, 1, . . . , S−1.

### 4. USE CASE

The encoder according to an embodiment is used in real-time encoding in remote play of a game.

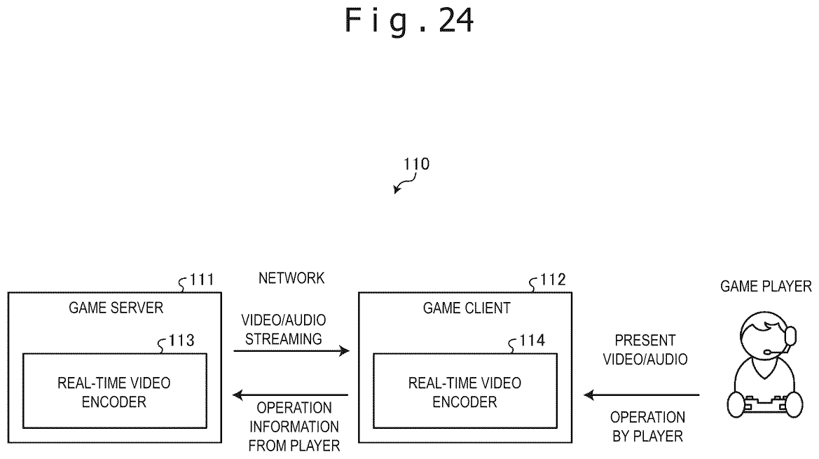

FIG. 24 is a diagram illustrating a game server 111 and a game client 112 in a game system 110 according to an embodiment. FIG. 24 is a block diagram focusing on an encoder and a decoder for video. As illustrated in FIG. 24, the game server 111 is connected to the game client 112 via a network. The game server 111 includes a real-time video encoder 113 according to an embodiment, and the game client 112 includes a real-time video decoder 114 that performs decoding corresponding to the real-time video encoder 113.

The game server 111 encodes the video of a game in real time, and transmits the encoded video and audio to the game client 112 via the network. The real-time video decoder 114 of the game client 112 decodes the video sent from the real-time video encoder 113 and presents the decoded video to the game player together with the audio. The game client 112 also transmits operation information of the player to the game server 111.

The game server 111 progresses the game on the basis of the operation information of the player sent from the game client 112, encodes the video of the game according to the progress by the real-time video encoder 113, and transmits the encoded video and audio to the game client 112.

In the game system 110 using VVC, the real-time video encoder 113 of the game server 111 and the real-time video decoder 114 of the game client 112 are required to operate in real time. The real-time video encoder 113 and the real-time video decoder 114 using the technology of an embodiment can meet such a demand.

Note that the game server 111 may be an on-premises server or a server on a cloud. A parallelization control scheme according to an embodiment can be applied to any tightly coupled High Performance Computing (HPC) system.

In addition, an on-premises computer system or a cloud computer system is constructed in any of various resource configuration formats. On the other hand, an image size, application program requirements for an image quality request, a network bandwidth, and a computing cost also vary. A parallelization control method of an embodiment can determine a configuration that is efficiently used (operated) in a scalable manner.

### 5. HARDWARE CONFIGURATION

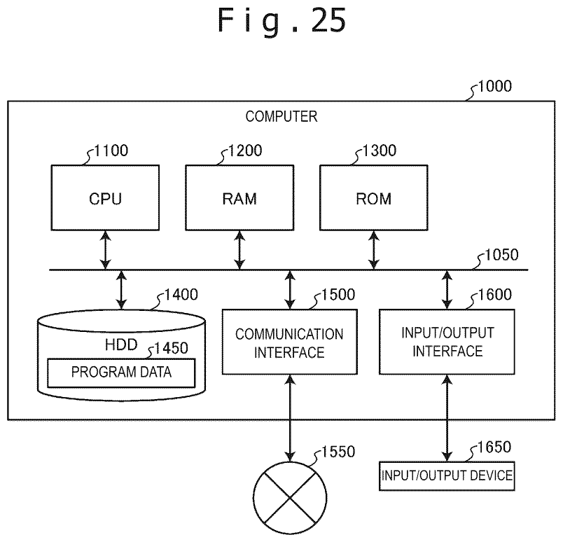

FIG. 25 is a hardware configuration diagram illustrating an example of a computer 1000 that realizes a computation apparatus of an information processing apparatus in which a VVC encoder is mounted, according to an embodiment.

The computer 1000 includes a CPU 1100, a RAM 1200, a Read Only Memory (ROM) 1300, a Hard Disk Drive (HDD) 1400, a communication interface 1500, and an input/output interface 1600. The sections of the computer 1000 are connected to one another via a bus 1050.

The CPU 1100 operates on the basis of a program stored in the ROM 1300 or the HDD 1400 to control each section. For example, the CPU 1100 loads programs stored in the ROM 1300 or the HDD 1400 into the RAM 1200 and executes processing corresponding to the various programs.

The ROM 1300 stores boot programs such as a Basic Input Output System (BIOS) which are executed by the CPU 1100 at the time of activation of the computer 1000, programs depending on hardware of the computer 1000, and the like.

The HDD 1400 is a computer-readable recording medium that non-transitorily records a program executed by the CPU 1100, and data and the like used by the program. In particular, the HDD 1400 is a recording medium for recording an application program according to the present disclosure, which is an example of program data 1450.

The communication interface 1500 is an interface for the computer 1000 to connect to an external network 1550 (for example, the Internet). For example, via the communication interface 1500, the CPU 1100 receives data from another equipment, and transmits, to another equipment, data generated by the CPU 1100.

The input/output interface 1600 is an interface for connecting an input/output device 1650 and the computer 1000. For example, the CPU 1100 receives data from input devices such as a keyboard and a mouse via the input/output interface 1600. The CPU 1100 also transmits data to output devices such as a display, speakers, and a printer via the input/output interface 1600. Additionally, the input/output interface 1600 may function as a media interface that reads a program or the like recorded in a predetermined recording medium (media). The medium is, for example, an optical recording medium such as a Digital Versatile Disc (DVD) or a Phase change rewritable Disk (PD), a magneto-optical recording medium such as a Magneto-Optical disk (MO), a tape medium, a magnetic recording medium, a semiconductor memory, or the like.

Note that the CPU 1100 reads the program data 1450 from the HDD 1400 and executes the programs, but in another example, the CPU 1100 may acquire these programs from another apparatus via the external network 1550.

Although the preferred embodiments of the present disclosure have been described in detail with reference to the accompanying drawings, the technical scope of the present disclosure is not limited to such examples. Apparently, a person having ordinary knowledge in the technical field of the present disclosure can conceive various changes or modifications within the scope of the technical idea recited in the claims, and it is understood that these also naturally belong to the technical scope of the present disclosure.

Additionally, the effects described in the present specification are merely explanatory or illustrative and are not restrictive. In other words, the technology according to the present disclosure can exhibit other effects that are apparent to those skilled in the art from the description of the present specification, together with the above effects or instead of the above effects.

Note that the present technology can also take the following configurations.

(1)

An information processing apparatus including:
a number-of-slices determination section configured to determine a number of slices on the basis of a set number of execution cores, set coding performance, and a set speed for a CTU to be encoded, the set number of execution cores, the set coding performance, and the set speed having been input; and
a combination determination section configured to determine a combination of a number of CTU parallel operations, a number of CU partition parallel operations, and a number of CU mode parallel operations, the CTU parallel operations, the CU partition parallel operations, and the CU mode parallel operations being to be performed in a respective slice for the number of slices subjected to the determination by the number-of-slices determination section.
   (2)

The information processing apparatus according to (1), further including:
a generation section configured to generate a control information database including the number of slices of the CTU, coding performance for the number of slices, a speed value having a plurality of speed patterns for the number of slices, and a number of execution cores having a plurality of patterns of the number of execution cores for the plurality of the speed patterns,
wherein each of the plurality of speed value patterns in the control information database has a combination of the number of CTU parallel operations, the number of CU partition parallel operations, and the number of CU mode parallel operations corresponding to the plurality of speed value patterns.
   (3)

The information processing apparatus according to (2), wherein
the number-of-slices determination section
extracts, from the control information database, an adoption candidate pattern that satisfies the set number of execution cores, the set coding performance, and the set speed for the CTU to be encoded, the set number of execution cores, the set coding performance, and the set speed being subjected to the input, and
determines the number of slices from the adoption candidate pattern obtained by the extraction.
   (4)

The information processing apparatus according to (3), wherein the extraction of the adoption candidate pattern is performed according to settings of the coding performance and the speed.

(5)

The information processing apparatus according to (2), wherein
the combination determination section
estimates an amount of processing of a respective slice for the number of slices subjected to the determination, and
determines the number of CTU parallel operations, the number of CU partition parallel operations, and the number of parallel CU mode parallel operations on the basis of the amount of processing of the respective slice obtained by the estimation.
   (6)

The information processing apparatus according to (5), wherein the amount of processing is estimated on the basis of an amount of processing of a past frame.

(7)

The information processing apparatus according to (5), wherein the amount of processing is estimated on the basis of at least one of a feature amount of an original image or a feature amount of ME.

(8)

The information processing apparatus according to (5), wherein the combination determination section:
calculates an adjustment value for searching for the speed value for the respective slice on the basis of the amount of processing of the respective slice obtained by the estimation, and
searches for the pattern of the speed value on the basis of the calculated adjustment value.
   (9)

The information processing apparatus according to (8), wherein
the combination determination section
adjusts the pattern of the number of execution cores corresponding to the pattern of the speed value obtained by the search, to the set number of execution cores subjected to the input, based on the number of slices subjected to the determination.
   (10)

The information processing apparatus according to (1), wherein the information processing apparatus is an encoder.

(11)

The information processing apparatus according to (1), wherein the information processing apparatus is a software encoder.

(12)

The information processing apparatus according to (1), wherein the information processing apparatus is a hardware encoder.

(13)

The information processing apparatus according to (1), wherein the information processing apparatus is a game server configured to encode and stream a video of a game.

(14)

An information processing method comprising:
determining a number of slices on the basis of a set number of execution cores, set coding performance, and a set speed for a CTU to be encoded, the set number of execution cores, the set coding performance, and the set speed having been input; and
determining a combination of a number of CTU parallel operations, a number of CU partition parallel operations, and a number of CU mode parallel operations, the CTU parallel operations, the CU partition parallel operations, and the CU mode parallel operations being to be performed in a respective slice for the number of slices subjected to the determination.

### REFERENCE SIGNS LIST

310 VVC encoder
311 Control information database generation section
312 Number-of-slices determination section
313 Parallelization method combination determination section
321 Control information database
322 Amount-of-processing estimation section
323 Parallelization method determination section

1. An information processing apparatus comprising:
a number-of-slices determination section configured to determine a number of slices on the basis of a set number of execution cores, set coding performance, and a set speed for a CTU to be encoded, the set number of execution cores, the set coding performance, and the set speed having been input; and
a combination determination section configured to determine a combination of a number of CTU parallel operations, a number of CU partition parallel operations, and a number of CU mode parallel operations, the CTU parallel operations, the CU partition parallel operations, and the CU mode parallel operations being to be performed in a respective slice for the number of slices subjected to the determination by the number-of-slices determination section.

2. The information processing apparatus according to claim 1, further comprising:
a generation section configured to generate a control information database including the number of slices of the CTU, coding performance for the number of slices, a speed value having a plurality of speed patterns for the number of slices, and a number of execution cores having a plurality of patterns of the number of execution cores for the plurality of the speed patterns,
wherein each of the plurality of speed value patterns in the control information database has a combination of the number of CTU parallel operations, the number of CU partition parallel operations, and the number of CU mode parallel operations corresponding to the plurality of speed value patterns.

3. The information processing apparatus according to claim 2, wherein
the number-of-slices determination section
extracts, from the control information database, an adoption candidate pattern that satisfies the set number of execution cores, the set coding performance, and the set speed for the CTU to be encoded, the set number of execution cores, the set coding performance, and the set speed being subjected to the input, and
determines the number of slices from the adoption candidate pattern obtained by the extraction.

4. The information processing apparatus according to claim 3, wherein the extraction of the adoption candidate pattern is performed according to settings of the coding performance and the speed.

5. The information processing apparatus according to claim 2, wherein
the combination determination section
estimates an amount of processing of a respective slice for the number of slices subjected to the determination, and
determines the number of CTU parallel operations, the number of CU partition parallel operations, and the number of parallel CU mode parallel operations on the basis of the amount of processing of the respective slice obtained by the estimation.

6. The information processing apparatus according to claim 5, wherein the amount of processing is estimated on the basis of an amount of processing of a past frame.

7. The information processing apparatus according to claim 5, wherein the amount of processing is estimated on the basis of at least one of a feature amount of an original image or a feature amount of ME.

8. The information processing apparatus according to claim 5, wherein
the combination determination section
calculates an adjustment value for searching for the speed value for the respective slice on the basis of the amount of processing of the respective slice obtained by the estimation, and
searches for the pattern of the speed value on the basis of the calculated adjustment value.

9. The information processing apparatus according to claim 8, wherein
the combination determination section
adjusts the pattern of the number of execution cores corresponding to the pattern of the speed value obtained by the search, to the set number of execution cores subjected to the input, based on the number of slices subjected to the determination.

10. The information processing apparatus according to claim 1, wherein the information processing apparatus is an encoder.

11. The information processing apparatus according to claim 1, wherein the information processing apparatus is a software encoder.

12. The information processing apparatus according to claim 1, wherein the information processing apparatus is a hardware encoder.

13. The information processing apparatus according to claim 1, wherein the information processing apparatus is a game server configured to encode and stream a video of a game.

14. An information processing method comprising:
determining a number of slices on the basis of a set number of execution cores, set coding performance, and a set speed for a CTU to be encoded, the set number of execution cores, the set coding performance, and the set speed having been input; and
determining a combination of a number of CTU parallel operations, a number of CU partition parallel operations, and a number of CU mode parallel operations, the CTU parallel operations, the CU partition parallel operations, and the CU mode parallel operations being to be performed in a respective slice for the number of slices subjected to the determination.
